(19) United States
(12) Patent Application Publication
(10) Pub. No.: US 2011/0300009 A1
(43) Pub. Date: Dec. 8, 2011

(54) Method of Processing Contact Portions between Valve Plate and Suction Valve and/or Discharge Valve of Reciprocating Compressor, and Reciprocating Compressor

(76) Inventors: Kiyoto Kikuchi, Gunma (JP); Junya Satou, Gunma (JP); Hiroyuki Endou, Gunma (JP); Tsutomu Ishikawa, Gunma (JP)

(21) Appl. No.: 13/148,033

(22) PCT Filed: Feb. 4, 2009
(86) PCT No.: PCT/JP2009/051902

§ 371 Date: Aug. 4, 2011

(51) Int. Cl. F04B 49/22; B24B 1/00; B05D 1/02; B23K 26/00

(52) U.S. Cl. 417/437; 219/121.72; 451/28; 427/446

(57) ABSTRACT

[Object of the Invention] An object of the present invention is to provide a method for processing contact portions between a valve plate and a suction valve and/or discharge valve of a reciprocating compressor to prevent the suction valve and/or the discharge valve from sticking on the valve plate at the portions contacting the valve plate, the productivity thereof being higher than that of the conventional method.

[Disclosure of the Invention] A method for processing contact portions between a valve plate 8 and a suction valve 10a and/or discharge valve 10b of a reciprocating compressor to prevent the suction valve 10a and/or the discharge valve 10b from sticking on the valve plate 8 at the portions contacting the valve plate 8 comprises the steps of quenching the portion of the end face of the valve plate 8 contacting the suction valve 10a near the suction hole 8a and/or the portion of the end face of the valve plate 8 contacting the discharge valve 10b near the discharge hole 8b by laser beam machining without melting them, and grinding the end face of the valve plate 8 contacting the suction valve 10a and/or the end face of the valve plate 8 contacting the discharge valve 10b to project the quenched portions from the remaining unquenched portions.

Method for processing contact portions between valve plate and suction valve and/or discharge valve of reciprocating compressor, and reciprocating compressor

### TECHNICAL FIELD

The present invention relates to a method for processing contact portions between a valve plate and a suction valve and/or discharge valve of a reciprocating compressor, and a reciprocating compressor.

### BACKGROUND ART

Patent Document No. 1 teaches a method for processing contact portions between a valve plate and a suction valve and/or discharge valve of a reciprocating compressor to prevent the suction valve and/or the discharge valve from sticking on the valve plate at the portions contacting the valve plate, wherein the compressor comprises a cylinder bore, a piston fitted in the cylinder bore to be capable of reciprocal movement, a valve plate provided with a suction hole and a discharge hole communicating with the cylinder bore, a strap-shaped suction valve for opening and closing the suction hole, a strap-shaped discharge valve for opening and closing the discharge hole, a suction chamber communicating with the cylinder bore through the suction hole and the suction valve, and a discharge chamber communicating with the cylinder bore through the discharge valve and the discharge hole, and wherein the method comprises the steps of melting and sputtering the portion of the end face of the valve plate contacting the suction valve around the suction hole by laser beam machining and/or the portion of the end face of the valve plate contacting the discharge valve around the discharge hole by laser beam machining, and projecting the non-laser-beam-machined-portions from the laser-beam-machined-portions.

The method of the Patent Document No. 1 has various advantages over the conventional processing method wherein projections are made by shot blasting, including, for example, that the processing media do not remain, the projections are formed precisely, etc.
Patent Document No. 1: Japanese Patent Laid-Open Publication No. 2007-064196

### DISCLOSURE OF INVENTION

### Problem to be Solved

The method of the Patent Document No. 1 has a disadvantage in that the productivity is low because precise processing is required to melt and sputter a part of the valve plate, and thereby form the projections.

The present invention is directed to solving the aforementioned problem. An object of the present invention is to provide a method for processing contact portions between a valve plate and a suction valve and/or discharge valve of a reciprocating compressor to prevent the suction valve and/or the discharge valve from sticking on the valve plate at the portions contacting the valve plate, wherein the compressor comprises a cylinder bore, a piston fitted in the cylinder bore to be capable of reciprocal movement, a valve plate provided with a suction hole and a discharge hole communicating with the cylinder bore, a strap-shaped suction valve for opening and closing the suction hole, a strap-shaped discharge valve for opening and closing the discharge hole, a suction chamber communicating with the cylinder bore through the suction hole and the suction valve, and a discharge chamber communicating with the cylinder bore through the discharge valve and the discharge hole, and wherein the productivity is higher than that in the method of the Patent Document No. 1.

### Means for Achieving the Object

In accordance with the present invention, there is provided a method for processing contact portions between a valve plate and a suction valve and/or discharge valve of a reciprocating compressor to prevent the suction valve and/or the discharge valve from sticking on the valve plate at the portions contacting the valve plate, wherein the compressor comprises a cylinder bore, a piston fitted in the cylinder bore to be capable of reciprocal movement, a valve plate provided with a suction hole and a discharge hole communicating with the cylinder bore, a strap-shaped suction valve for opening and closing the suction hole, a strap-shaped discharge valve for opening and closing the discharge hole, a suction chamber communicating with the cylinder bore through the suction hole and the suction valve, and a discharge chamber communicating with the cylinder bore through the discharge valve and the discharge hole, and wherein the method comprises the steps of quenching the portion of the end face of the valve plate contacting the suction valve near the suction hole and/or the portion of the end face of the valve plate contacting the discharge valve near the discharge hole by laser beam machining without melting them, and grinding the end face of the valve plate contacting the suction valve and/or the end face of the valve plate contacting the discharge valve to project the quenched portions from the remaining unquenched portions.

In another aspect of the present invention, there is provided a method for processing contact portions between a valve plate and a suction valve and/or discharge valve of a reciprocating compressor to prevent the suction valve and/or the discharge valve from sticking on the valve plate at the portions contacting the valve plate, wherein the compressor comprises a cylinder bore, a piston fitted in the cylinder bore to be capable of reciprocal movement, a valve plate provided with a suction hole and a discharge hole communicating with the cylinder bore, a strap-shaped suction valve for opening and closing the suction hole, a strap-shaped discharge valve for opening and closing the discharge hole, a suction chamber communicating with the cylinder bore through the suction hole and the suction valve, and a discharge chamber communicating with the cylinder bore through the discharge valve and the discharge hole, and wherein the method comprises the steps of quenching the portion of the end face of the suction valve contacting the valve plate opposing the portion of the valve plate near the suction hole and/or the portion of the end face of the discharge valve contacting the valve plate opposing the portion of the valve plate near the discharge hole by laser beam machining without melting them, and grinding the end face of the suction valve and/or the end face of the discharge valve to project the quenched portions from the remaining unquenched portions.

In the present invention, a portion of the valve plate, or the suction valve, or the discharge valve is quenched by laser beam machining without being melted, and the valve plate, or the suction valve, or the discharge valve is ground to form a projection. Therefore, the productivity is higher in the present invention than that in the conventional method, wherein the valve plate is melted and sputtered partially to form projections.

In accordance with the present invention, there is provided a method for processing contact portions between a valve plate and a suction valve and/or discharge valve of a reciprocating compressor to prevent the suction valve and/or the discharge valve from sticking on the valve plate at the portions contacting the valve plate, wherein the compressor comprises a cylinder bore, a piston fitted in the cylinder bore to be capable of reciprocal movement, a valve plate provided with a suction hole and a discharge hole communicating with the cylinder bore, a strap-shaped suction valve for opening and closing the suction hole, a strap-shaped discharge valve for opening and closing the discharge hole, a suction chamber communicating with the cylinder bore through the suction hole and the suction valve, and a discharge chamber communicating with the cylinder bore through the discharge valve and the discharge hole, and wherein the method comprises the step of making any one of a resin coat, plated metal coat, thermal sprayed material coat, sintered metal coat and ceramic coat on the portion of the end face of the valve plate contacting the suction valve near the suction hole and/or the portion of the end face of the valve plate contacting the discharge valve near the discharge hole to project the coated portions from the remaining uncoated portions.

In another aspect of the present invention, there is provided a method for processing contact portions between a valve plate and a suction valve and/or discharge valve of a reciprocating compressor to prevent the suction valve and/or the discharge valve from sticking on the valve plate at the portions contacting the valve plate, wherein the compressor comprises a cylinder bore, a piston fitted in the cylinder bore to be capable of reciprocal movement, a valve plate provided with a suction hole and a discharge hole communicating with the cylinder bore, a strap-shaped suction valve for opening and closing the suction hole, a strap-shaped discharge valve for opening and closing the discharge hole, a suction chamber communicating with the cylinder bore through the suction hole and the suction valve, and a discharge chamber communicating with the cylinder bore through the discharge valve and the discharge hole, and wherein the method comprises the step of making any one of a resin coat, plated metal coat, thermal sprayed material coat, sintered metal coat and ceramic coat on the portion of the end face of the suction valve contacting the valve plate opposing the portion of the valve plate near the suction hole and/or the portion of the end face of the discharge valve contacting the valve plate opposing the portion of the valve plate near the discharge hole to project the coated portions from the remaining uncoated portions.

In the present invention, a portion of the valve plate, or the suction valve, or the discharge valve is provided with any one of a resin coat, plated metal coat, thermal sprayed material coat, sintered metal coat and ceramic coat to be projected. Therefore, the productivity is higher in the present invention than that in the conventional method, wherein the valve plate is melted and sputtered partially to form projections.

The portion near the suction hole may be any one of a continuous annular portion around the suction hole, an intermittent annular portion around the suction hole, a continuous arc portion extending along a part of the periphery of the suction hole, an intermittent arc portion extending along a part of the periphery of the suction hole, a continuous straight portion close to the periphery of the suction hole, and an intermittent straight portion close to the periphery of the suction hole. The portion near the discharge hole may be any one of a continuous annular portion around the discharge hole, an intermittent annular portion around the discharge hole, a continuous arc portion extending along a part of the periphery of the discharge hole, an intermittent arc portion extending along a part of the periphery of the discharge hole, a continuous straight portion close to the periphery of the discharge hole, and an intermittent straight portion close to the periphery of the discharge hole.

In a reciprocating compressor, wherein a plurality of cylinder bores are disposed to be circumferentially distanced from each other and located on the circumference of a first circle, a plurality of suction holes are disposed to be circumferentially distanced from each other and located on the circumference of a second circle, and a plurality of discharge holes are disposed to be circumferentially distanced from each other and located on the circumference of a third circle, it is possible to quench without melting the end face of the valve plate contacting the suction valves at an intermittent annular portion crossing all of the suction holes and/or the end face of the valve plate contacting the discharge valves at an intermittent annular portion crossing all of the discharge holes, or the end face of the valve plate contacting the suction valves at a continuous annular portion close to all of the suction holes and/or the end face of the valve plate contacting the discharge valves at a continuous annular portion close to all of the discharge holes by laser beam machining, and grind the end face of the valve plate contacting the suction valves and/or the end face of the valve plate contacting the discharge valves to project the quenched portions from the remaining unquenched portions. The productivity improves as the laser beam machining can be done by one pass or a small number of passes.

In a reciprocating compressor, wherein a plurality of cylinder bores are disposed to be circumferentially distanced from each other and located on the circumference of a first circle, a plurality of suction holes are disposed to be circumferentially distanced from each other and located on the circumference of a second circle, and a plurality of discharge holes are disposed to be circumferentially distanced from each other and located on the circumference of a third circle, it is possible to make any one of a resin coat, plated metal coat, thermal sprayed material coat, sintered metal coat and ceramic coat on the end face of the valve plate contacting the suction valves at an intermittent annular portion crossing all of the suction holes and/or the end face of the valve plate contacting the discharge valves at an intermittent annular portion crossing all of the discharge holes, or the end face of the valve plate contacting the suction valves at a continuous annular portion close to all of the suction holes and/or the end face of the valve plate contacting the discharge valves at a continuous annular portion close to all of the discharge holes to project the coated portions from the remaining uncoated portions. The productivity improves as the making of the coat can be done by one pass or a small number of passes.

If the width of the projection is too small, the projection wears easily. If the width of the projection is too large, the valve easily sticks on the projection. Therefore, the width of the projection is desirably 0.1 to 2.0 mm.

If the height of the projection is too small, the projection wears easily. If the height of the projection is too large, the valve is liable to close incompletely. Therefore, the height of the projection is desirably 0.01 to 0.5 mm.

If the surface roughness of the projection is too large, a gap is formed between the projection and the valve or the valve plate contacting the projection to cause leakage of gas during the compressing process or sucking process, thereby decreasing compression efficiency. Therefore, the surface roughness of the projection is desirably less than that of the remaining flat unquenched portions and desirably Rz10 or less.

If the difference of hardness between the quenched portion and the unquenched portion is small, no projection can be made by grinding. Therefore, the hardness of the quenched portion is desirably higher than that of the unquenched portions by HV100 or more.

A CO₂ laser is suitable for the quenching process as its output is large.

A resin coat has an advantage in that it can be made easily. Among the various kinds of resin coats, a fluoride resin coat repels oil to suppress generation of oil film. Therefore, a fluoride resin coat is effective for preventing the suction valve and/or the discharge valve from sticking on the valve plate.

Desirably, a binder resin such as polyamideimide, epoxy, polyimide, polyamide, polyether ether ketone, etc. is used to enhance the adherence between the fluoride resin coat and the base material.

Forming the resin coat by screen printing is good in recovery of coating material.

Desirably, pre-coat treating such as chemical conversion treating. TuffLride processing, shot blasting, etc. is carried out on the base material to enhance the adherence between the resin coat and the base material.

A sintered metal coat has an advantage in that it is superior in wear resistance and peeling resistance. When the sintered metal coat is porous, it absorbs oil to suppress generation of oil film. Therefore, a porous sintered metal coat is effective for preventing the suction valve and/or discharge valve from sticking on the valve plate. When a porous sintered metal coat is used for preventing the suction valve and/or discharge valve from sticking on the valve plate, the porous sintered metal coat may cover the entire end surface of the valve plate opposing the suction valve and/or the discharge valve.

When the porous sintered metal coat is impregnated with PTFE, i.e., polytetrafluoroethylene, it repels oil to suppress generation of oil film. Therefore, the porous sintered metal coat impregnated with PTFE is effective for preventing the suction valve and/or discharge valve from sticking on the valve plate.

### Effect of the Invention

In the present invention, a portion of the valve plate, or the suction valve, or the discharge valve is quenched by laser beam machining without being melted, and the valve plate, or the suction valve, or the discharge valve is ground to form a projection. Therefore, the productivity is higher in the present invention than that in the conventional method, wherein the valve plate is melted and sputtered partially to form projections.

In the present invention, a portion of the valve plate, or the suction valve, or the discharge valve is provided with any one of a resin coat, plated metal coat, thermal sprayed material coat, sintered metal coat and ceramic coat to project. Therefore, the productivity is higher in the present invention than that in the conventional method, wherein the valve plate is melted and sputtered partially to form projections.

### BEST MODE FOR CARRYING OUT THE INVENTION

A method for processing contact portions between a valve plate and a suction valve and/or discharge valve of a reciprocating compressor in accordance with a preferred embodiment of the present invention will be described.

### Preferred Embodiment No. 1

As shown in FIG. 1, a variable displacement swash plate compressor 1 comprises a cylinder block 2 provided with a plurality of cylinder bores 2a of circular cross section, a front head 4 cooperating with the cylinder block 2 to form a crank chamber 3, a rotation shaft 5 disposed in the crank chamber 3, rotatably supported by the cylinder block 2 and the front head 4, and extending out of the compressor through the front head 4 at one end, a swash plate 6 engaging the rotation shaft 5 at a variable inclination and rotated by the rotation shaft 5, a plurality of pistons 7 fitted in the cylinder bores 2a, engaging the swash plate 6, and reciprocally moving synchronously with the rotation of the swash plate 6, a cylinder head 9 accommodating a hollow-annular-shaped suction chamber 9a and a hollow-disk-shaped discharge chamber 9b and cooperating with the cylinder block 2 to clamp a valve plate 8 provided with a plurality of suction holes 8a and discharge holes 8b, a plurality of strap-shaped suction valves 10a clamped by the cylinder block 2 and the valve plate 8 to be fixed at one ends and opening and closing the suction holes 8a at the other ends, and a plurality of strap-shaped discharge valves 10b clamped by valve retainers 11 and the valve plate 8 to be fixed at one ends and opening and closing the discharge holes 8b at the other ends.

The plurality of cylinder bores 2a are disposed circumferentially distanced from each other on the circumference of a first circle. The plurality of suction holes 8a are disposed circumferentially distanced from each other on the circumference of a second circle. The plurality of discharge holes 8b are disposed circumferentially distanced from each other on the circumference of a third circle.

The suction chamber 9a communicates with an evaporator of a car air conditioner not shown in FIG. 1 through a suction port 9a′ and with the cylinder bores 2a through the suction holes 8a and the suction valves 10a.

The discharge chamber 9b communicates with a condenser of a car air conditioner not shown in FIG. 1 through a discharge port 9b′ and with the cylinder bores 2a through the discharge valves 10b and the discharge holes 8b.

A plurality of concaves 2b are formed on the end face of the cylinder block 2 opposing the valve plate 8 to restrict the lifts of the suction valves 10a.

As shown in FIG. 2(a), the end face of the valve plate 8, which is made of steel, contacting the suction valves 10a is quenched without being melted by CO₂ laser beam machining at portions near the suction holes 8a, more specifically, continuous annular portions R1 around the suction holes 8a. Then, the end face of the valve plate 8 contacting the suction valves 10a is ground to project the quenched portions from the remaining unquenched portions. In the same way, the end face of the valve plate 8 contacting the discharge valves 10b is quenched without being melted by CO₂ laser beam machining at portions near the discharge holes 8b, more specifically, continuous annular portions R1′ around the discharge holes 8b. Then, the end face of the valve plate 8 contacting the discharge valves 10b is ground to project the quenched portions from the remaining unquenched portions.

The continuous annular quenched portions may be constituted of many quenched dots made by a sharply focused thin laser beam or a quenched belt made by an unsharply focused thick laser beam.

As shown in FIG. 3, the width of the projections is set at 0.1 mm to 2.0 mm and the height of the projections is set at 0.01 mm to 0.5 mm. The surface roughness of the projections is set at Rz10 or less. The hardness of the quenched portions is set at a level higher than that of the unquenched portions by HV100 or more.

In the variable displacement swash plate compressor 1, the rotation shaft 5 is rotated by a car engine not shown in the Figures, the swash plate 6 rotates synchronously with the rotation of the rotation shaft 5, and the pistons 7 reciprocally move. Synchronously with the reciprocal movement of the pistons 7, coolant gas returns to the compressor from the evaporator of the car air conditioner, flows into the cylinder bores 2a through the suction port 9a′, the suction chamber 9a, the suction holes 8a and the suction valves 10a, becomes compressed in the cylinder bores 2a, and flows out of the compressor 1 to the condenser of the car air conditioner through the discharge holes 8b, the discharge valves 10b, the discharge chamber 9b and the discharge port 9b′.

In the variable displacement swash plate compressor 1, the end face of the valve plate 8 contacting the suction valves 10a is provided with projections at the portions near the suction holes 8a and the end face of the valve plate 8 contacting the discharge valves 10b is provided with projections at the portions near the discharge holes 8b. Therefore, the sticking of the suction valves 10a and the discharge valves 10b on the valve plate 8 caused by adhesion of lubricant oil dispersed in coolant gas is suppressed, delays in the opening actions of the suction valves 10a and the discharge valves 10b are prevented, and damage of the suction valves 10a and the discharge valves 10b and generation of noises caused by hard collisions between the tips of the suction valves 10a and the concaves 2b for restricting the lifts of the suction valves 10a and hard collisions between the discharge valves 10b and the valve retainers 11 due to delays in the opening actions of the suction valves 10a and the discharge valves 10b are prevented.

In the variable displacement swash plate compressor 1, some portions of the valve plate 8 are quenched by laser beam machining without being melted, and the valve plate 8 is ground to form projections. Therefore, the productivity of projection formation is high.

If the width of the projections is too small, the projections wear easily. If the width of the projections is too large, the valves easily stick on the projections. Therefore, the width of the projections is desirably 0.1 to 2.0 mm.

If the height of the projections is too small, the projections wear easily. If the height of the projections is too large, the valves are liable to close incompletely. Therefore, the height of the projections is desirably 0.01 to 0.5 mm.

If the surface roughness of the projections is too large, gaps are formed between the projections and the suction valves 10a and between the projections and the discharge valves 10b to cause leakage of gas during the compressing process or sucking process, thereby decreasing compression efficiency. Therefore, the surface roughness of the projections is desirably less than that of the remaining flat unquenched portions and desirably Rz10 or less.

If the difference of hardness between the quenched portions and the unquenched portions is small, no projection can be made by grinding. Therefore, the hardness of the quenched portions is desirably higher than that of the unquenched portions by HV100 or more.

A CO₂ laser is suitable for the quenching process as its output is large.

The portions near the suction holes to be quenched may be any one of intermittent annular portions R2, R3 shown in FIGS. 2(b), 2(c) around the suction holes 8a, continuous arc portions R4 shown in FIG. 2(d) each thereof extending along a part of the periphery of each suction hole 8a, intermittent arc portions R5 shown in FIG. 2(e) each thereof extending along a part of the periphery of each suction hole 8a, continuous single straight portions R6 or continuous multiple straight portions R7 shown in FIG. 2(f) or 2(g) close to the peripheries of the suction holes 8a, and intermittent single straight portions or intermittent multiple straight portions close to the peripheries of the suction holes 8a.

The portions near the discharge holes to be quenched may be any one of intermittent annular portions R2′, R3′ shown in FIGS. 2(b), 2(c) around the discharge holes 8b, continuous arc portions R4′ shown in FIG. 2(d) each thereof extending along a part of the periphery of each discharge hole 8b, intermittent arc portions R5′ shown in FIG. 2(e) each thereof extending along a part of the periphery of each discharge hole 8b, continuous single straight portions R6′ or continuous multiple straight portions R7′ shown in FIG. 2(f) or 2(g) close to the peripheries of the discharge holes 8b, and intermittent single straight portions or intermittent multiple straight portions close to the peripheries of the discharge holes 8b.

As shown in FIGS. 4(a) and 4(b), it is possible to quench without melting the end face of the valve plate 8 contacting the suction valves 10a at an intermittent annular portion R8 or a plurality of intermittent annular portions R9 crossing all of the suction holes 8a and the end face of the valve plate 8 contacting the discharge valves 10b at an intermittent annular portion R8′ or a plurality of intermittent annular portions R9′ crossing all of the discharge holes 8b by CO₂ laser beam machining, and grind the end face of the valve plate 8 contacting the suction valves 10a and the end face of the valve plate 8 contacting the discharge valves 10b to make the quenched portions project from the remaining unquenched portions.

As shown in FIG. 4(c), it is possible to quench without melting the end face of the valve plate 8 contacting the suction valves 10a at a continuous annular portion R10 close to all of the suction holes 8a and the end face of the valve plate 8 contacting the discharge valves 10b at a continuous annular portion R10′ close to all of the discharge holes 8b by CO₂ laser beam machining, and grind the end face of the valve plate 8 contacting the suction valves 10a and the end face of the valve plate 8 contacting the discharge valves 10b to make the quenched portions project from the remaining unquenched portions.

The annular quenched portions may be constituted of many quenched dots made by a sharply focused thin laser beam or a quenched belt made by an unsharply focused thick laser beam.

In FIGS. 4(a) and 4(c), the laser beam machining can be finished by one pass, and in FIG. 4(b), the laser beam machining can be finished by a small number of passes. Thus, the productivity improves.

In the aforementioned embodiment, projections are formed on the end face of the valve plate 8 contacting the suction valve 10a and the end face of the valve plate 8 contacting the discharge valves 10b. The projections may be formed on either the end face of the valve plate 8 contacting the suction valve 10a or the end face of the valve plate 8 contacting the discharge valves 10b.

In the aforementioned embodiment, projections are formed on the valve plate 8. The projections shown in FIGS. 2(a) to 2(g) may be formed on the suction valves 10a and/or the discharge valves 10b by the same process as in the case where the projections are formed on the valve plate 8.

Instead of quenching by laser beam machining and grinding to form projections, it is possible to form projections by any one of a resin coat, plated metal coat, such as plated nickel coat, plated chromium coat, plated iron coat, etc., thermal sprayed material coat, such as thermal sprayed metal coat, thermal sprayed ceramic coat, etc., sintered metal coat, such as sintered iron alloy coat, sintered copper alloy coat, etc., and ceramic coat, such as aluminum oxide coat, silicon oxide coat, etc. Productivity improves because forming projections by coating does not need machining so precise as forming projections by laser beam machining to melt and sputter.

A resin coat has an advantage in that it can be made easily. Among the various kinds of resin coats, fluoride resin coat repels oil to suppress generation of oil film. Therefore, fluoride resin coat is effective for preventing the suction valves 10a and/or the discharge valves 10b from sticking on the valve plate 8.

Desirably, binder resin such as polyamideimide, epoxy, polyimide, polyamide, polyether ether ketone, etc. is mixed with the fluoride resin so as to enhance the adherence between the fluoride resin coat and the base material.

Forming of the resin coat by screen printing is good in recovery of coating material.

Desirably, pre-coat surface treatment such as chemical conversion treating. Tufftride processing, shot blasting, etc. is carried out on the suction valves 10a, the discharge valves 10b or the valve plate 8 to enhance the adherence between the resin coat and the suction valves 10a, the discharge valves 10b or the valve plate 8.

A sintered metal coat has an advantage in that it is superior in wear resistance and peeling resistance. When the sintered metal coat is porous, it absorbs oil to suppress generation of oil film. Therefore, a porous sintered metal coat is effective for preventing the suction valves 10a and/or the discharge valves 10b from sticking on the valve plate 8. When a porous sintered metal coat is used for preventing the suction valves 10a and/or the discharge valves 10b from sticking on the valve plate 8, the porous sintered metal coat may cover the entire end surface of the valve plate 8 opposing the suction valves 10a and/or the discharge valves 10b.

When the porous sintered metal coat is impregnated with PTFE, i.e., polytetrafluoroethylene, it repels oil to suppress generation of oil film. Therefore, the porous sintered metal coat impregnated with PTFE is effective for preventing the suction valves 10a and/or discharge valves 10b from sticking on the valve plate 8.

### INDUSTRIAL APPLICABILITY

The present invention can be widely used in various kinds of reciprocating compressors including swash plate compressors, wobble plate compressors, etc.

### BRIEF DESCRIPTION OF THE DRAWINGS

FIG. 1 is a sectional view of a variable displacement swash plate compressor to which the method for processing the contact portions between the valve plate and the suction valves and/or discharge valves of a reciprocating compressor in accordance with a preferred embodiment of the present invention is used.

FIG. 2 is a set of plan views of a contact portion between a valve plate and a suction valve and a set of plan views of a contact portion between a valve plate and a discharge valve for describing the method for processing in accordance with a preferred embodiment of the present invention.

FIG. 3 is a sectional view of a contact portion between a valve plate and a suction valve and a sectional view of a contact portion between a valve plate and a discharge valve for describing the method for processing in accordance with a preferred embodiment of the present invention.

FIG. 4 is a set of plan views of a contact portion between a valve plate and a suction valve and a set of plan views of a contact portion between a valve plate and a discharge valve for describing the method for processing in accordance with a preferred embodiment of the present invention.

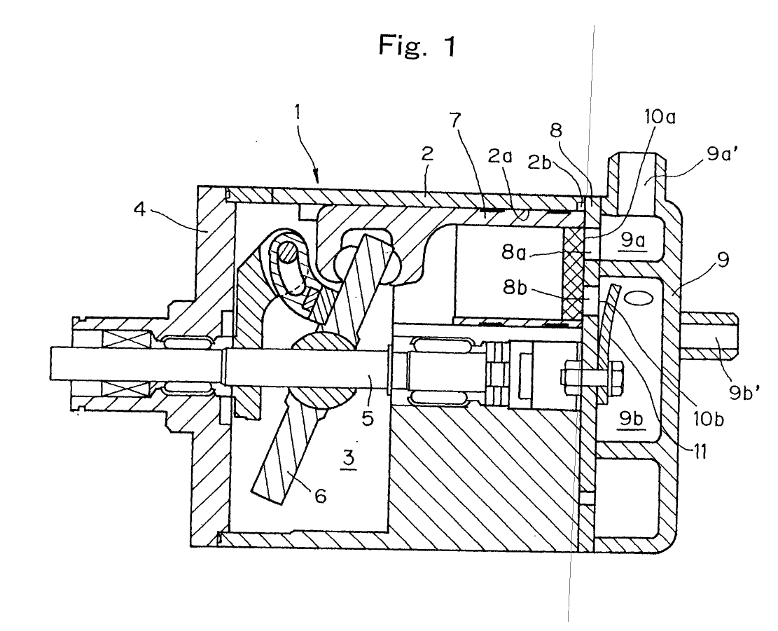

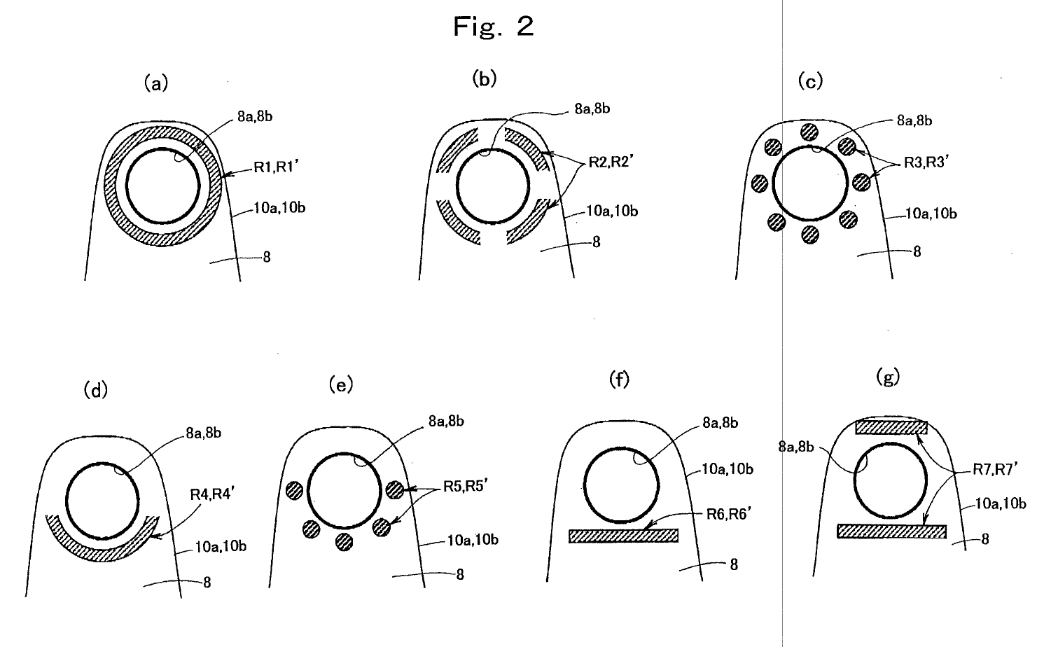

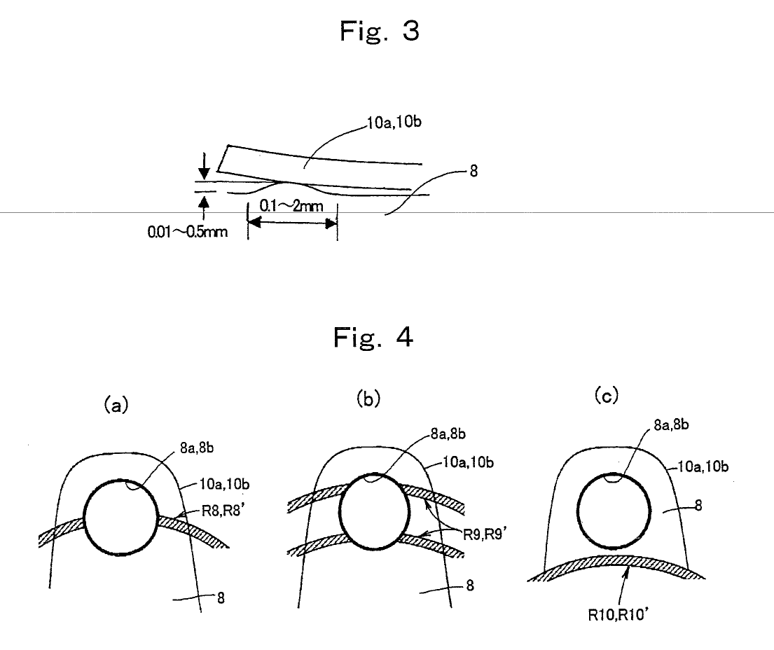

### BRIEF DESCRIPTION OF THE REFERENCE NUMERALS

1 Variable displacement swash plate compressor
2 Cylinder block
2a Cylinder bore
2b Concave for restricting the lift
3 Crank chamber
4 Front head
5 Rotation shaft
6 Swash plate
7 Piston
8 Valve plate
8a Suction hole
8b Discharge hole
9 Cylinder head
9a Suction chamber
9b Discharge chamber
10a Suction valve
10b Discharge valve
11 Valve retainer
R1, R1′ Continuous annular portion
R2,R3,R2′,R3′ Intermittent annular portion
R4, R4′ Continuous arc portion
R5, R5′ Intermittent arc portion
R6,R7,R6′,R7′ Continuous straight portion
R8,R9,R8′,R9′ Intermittent straight portion
R10, R10′ Continuous annular portion

1. A method for processing contact portions between a valve plate and a suction valve and/or discharge valve of a reciprocating compressor to prevent the suction valve and/or the discharge valve from sticking on the valve plate at the portions contacting the valve plate, wherein the compressor comprises a cylinder bore, a piston fitted in the cylinder bore to be capable of reciprocal movement, a valve plate provided with a suction hole and a discharge hole communicating with the cylinder bore, a strap-shaped suction valve for opening and closing the suction hole, a strap-shaped discharge valve for opening and closing the discharge hole, a suction chamber communicating with the cylinder bore through the suction hole and the suction valve, and a discharge chamber communicating with the cylinder bore through the discharge valve and the discharge hole, and wherein the method comprises the steps of quenching the portion of the end face of the valve plate contacting the suction valve near the suction hole and/or the portion of the end face of the valve plate contacting the discharge valve near the discharge hole by laser beam machining without melting them, and grinding the end face of the valve plate contacting the suction valve and/or the end face of the valve plate contacting the discharge valve to project the quenched portions from the remaining unquenched portions.

2. A method for processing contact portions between a valve plate and a suction valve and/or discharge valve of a reciprocating compressor to prevent the suction valve and/or the discharge valve from sticking on the valve plate at the portions contacting the valve plate, wherein the compressor comprises a cylinder bore, a piston fitted in the cylinder bore to be capable of reciprocal movement, a valve plate provided with a suction hole and a discharge hole communicating with the cylinder bore, a strap-shaped suction valve for opening and closing the suction hole, a strap-shaped discharge valve for opening and closing the discharge hole, a suction chamber communicating with the cylinder bore through the suction hole and the suction valve, and a discharge chamber communicating with the cylinder bore through the discharge valve and the discharge hole, and wherein the method comprises the step of making any one of a resin coat, plated metal coat, thermal sprayed material coat, sintered metal coat and ceramic coat on the portion of the end face of the valve plate contacting the suction valve near the suction hole and/or the portion of the end face of the valve plate contacting the discharge valve near the discharge hole to project the coated portions from the remaining uncoated portions.

3. A method for processing contact portions between a valve plate and a suction valve and/or discharge valve of a reciprocating compressor to prevent the suction valve and/or the discharge valve from sticking on the valve plate at the portions contacting the valve plate, wherein the compressor comprises a cylinder bore, a piston fitted in the cylinder bore to be capable of reciprocal movement, a valve plate provided with a suction hole and a discharge hole communicating with the cylinder bore, a strap-shaped suction valve for opening and closing the suction hole, a strap-shaped discharge valve for opening and closing the discharge hole, a suction chamber communicating with the cylinder bore through the suction hole and the suction valve, and a discharge chamber communicating with the cylinder bore through the discharge valve and the discharge hole, and wherein the method comprises the steps of quenching the portion of the end face of the suction valve contacting the valve plate opposing the portion of the valve plate near the suction hole and/or the portion of the end face of the discharge valve contacting the valve plate opposing the portion of the valve plate near the discharge hole by laser beam machining without melting them, and grinding the end face of the suction valve and/or the end face of the discharge valve to project the quenched portions from the remaining unquenched portions.

4. A method for processing contact portions between a valve plate and a suction valve and/or discharge valve of a reciprocating compressor to prevent the suction valve and/or the discharge valve from sticking on the valve plate at the portions contacting the valve plate, wherein the compressor comprises a cylinder bore, a piston fitted in the cylinder bore to be capable of reciprocal movement, a valve plate provided with a suction hole and a discharge hole communicating with the cylinder bore, a strap-shaped suction valve for opening and closing the suction hole, a strap-shaped discharge valve for opening and closing the discharge hole, a suction chamber communicating with the cylinder bore through the suction hole and the suction valve, and a discharge chamber communicating with the cylinder bore through the discharge valve and the discharge hole, and wherein the method comprises the step of making any one of a resin coat, plated metal coat, thermal sprayed material coat, sintered metal coat and ceramic coat on the portion of the end face of the suction valve contacting the valve plate opposing the portion of the valve plate near the suction hole and/or the portion of the end face of the discharge valve contacting the valve plate opposing the portion of the valve plate near the discharge hole to project the coated portions from the remaining uncoated portions.

5. The method for processing contact portions between a valve plate and a suction valve and/or discharge valve of a reciprocating compressor of claim 1, wherein the portion near the suction hole is a continuous annular portion around the suction hole and the portion near the discharge hole is a continuous annular portion around the discharge holes.

6. The method for processing contact portions between a valve plate and a suction valve and/or discharge valve of a reciprocating compressor of claim 1, wherein the portion near the suction hole is an intermittent annular portion around the suction hole and the portion near the discharge hole is an intermittent annular portion around the discharge hole.

7. The method for processing contact portions between a valve plate and a suction valve and/or discharge valve of a reciprocating compressor of claim 1, wherein the portion near the suction hole is a continuous arc portion extending along a part of the periphery of the suction hole and the portion near the discharge hole is a continuous arc portion extending along a part of the periphery of the discharge hole.

8. The method for processing contact portions between a valve plate and a suction valve and/or discharge valve of a reciprocating compressor of claim 1, wherein the portion near the suction hole is an intermittent arc portion extending along a part of the periphery of the suction hole and the portion near the discharge hole is an intermittent arc portion extending along a part of the periphery of the discharge hole.

9. The method for processing contact portions between a valve plate and a suction valve and/or discharge valve of a reciprocating compressor of claim 1, wherein the portion near the suction hole is a continuous straight portion near the suction hole and the portion near the discharge hole is a continuous straight portion near the discharge hole.

10. The method for processing contact portions between a valve plate and a suction valve and/or discharge valve of a reciprocating compressor of claim 1, wherein the portion near the suction hole is an intermittent straight portion near the suction hole and the portion near the discharge hole is an intermittent straight portion near the discharge hole.

11. A method for processing contact portions between a valve plate and a suction valve and/or discharge valve of a reciprocating compressor to prevent the suction valve and/or the discharge valve from sticking on the valve plate at the portions contacting the valve plate, wherein the compressor comprises cylinder bores, pistons fitted in the cylinder bores to be capable of reciprocal movement, a valve plate provided with suction holes and discharge holes communicating with the cylinder bores, strap-shaped suction valves for opening and closing the suction holes, strap-shaped discharge valves for opening and closing the discharge holes, a suction chamber communicating with the cylinder bores through the suction holes and the suction valves, and a discharge chamber communicating with the cylinder bores through the discharge valves and the discharge holes, and wherein the cylinder bores are circumferentially distanced from each other and located on the circumference of a first circle, the suction holes are circumferentially distanced from each other and located on the circumference of a second circle, and the discharge holes are circumferentially distanced from each other and located on the circumference of a third circle, and wherein the method comprises the steps of quenching the end face of the valve plate contacting the suction valves at an intermittent annular portion crossing all of the suction holes and/or the end face of the valve plate contacting the discharge valves at an intermittent annular portion crossing all of the discharge holes by laser beam machining without melting them, and grinding the end face of the valve plate contacting the suction valves and/or the end face of the valve plate contacting the discharge valves to project the quenched portions from the remaining unquenched portions.

12. A method for processing contact portions between a valve plate and a suction valve and/or discharge valve of a reciprocating compressor to prevent the suction valve and/or the discharge valve from sticking on the valve plate at the portions contacting the valve plate, wherein the compressor comprises cylinder bores, pistons fitted in the cylinder bores to be capable of reciprocal movement, a valve plate provided with suction holes and discharge holes communicating with the cylinder bores, strap-shaped suction valves for opening and closing the suction holes, strap-shaped discharge valves for opening and closing the discharge holes, a suction chamber communicating with the cylinder bores through the suction holes and the suction valves, and a discharge chamber communicating with the cylinder bores through the discharge valves and the discharge holes, and wherein the cylinder bores are circumferentially distanced from each other and located on the circumference of a first circle, the suction holes are circumferentially distanced from each other and located on the circumference of a second circle, and the discharge holes are circumferentially distanced from each other and located on the circumference of a third circle, and wherein the method comprises the step of making any one of a resin coat, plated metal coat, thermal sprayed material coat, sintered metal coat and ceramic coat on the end face of the valve plate contacting the suction valves at an intermittent annular portion crossing all of the suction holes and/or the end face of the valve plate contacting the discharge valves at an intermittent annular portion crossing all of the discharge holes to project the coated portions from the remaining uncoated portions.

13. A method for processing contact portions between a valve plate and a suction valve and/or discharge valve of a reciprocating compressor to prevent the suction valve and/or the discharge valve from sticking on the valve plate at the portions contacting the valve plate, wherein the compressor comprises cylinder bores, pistons fitted in the cylinder bores to be capable of reciprocal movement, a valve plate provided with suction holes and discharge holes communicating with the cylinder bores, strap-shaped suction valves for opening and closing the suction holes, strap-shaped discharge valves for opening and closing the discharge holes, a suction chamber communicating with the cylinder bores through the suction holes and the suction valves, and a discharge chamber communicating with the cylinder bores through the discharge valves and the discharge holes, and wherein the cylinder bores are circumferentially distanced from each other and located on the circumference of a first circle, the suction holes are circumferentially distanced from each other and located on the circumference of a second circle, and the discharge holes are circumferentially distanced from each other and located on the circumference of a third circle, and wherein the method comprises the steps of quenching the end face of the valve plate contacting the suction valves at a continuous annular portion close to an of the suction holes and/or the end face of the valve plate contacting the discharge valves at a continuous annular portion close to all of the discharge holes by laser beam machining without melting them, and grinding the end face of the valve plate contacting the suction valves and/or the end face of the valve plate contacting the discharge valves to project the quenched portions from the remaining unquenched portions.

14. A method for processing contact portions between a valve plate and a suction valve and/or discharge valve of a reciprocating compressor to prevent the suction valve and/or the discharge valve from sticking on the valve plate at the portions contacting the valve plate, wherein the compressor comprises cylinder bores, pistons fitted in the cylinder bores to be capable of reciprocal movement, a valve plate provided with suction holes and discharge holes communicating with the cylinder bores, strap-shaped suction valves for opening and closing the suction holes, strap-shaped discharge valves for opening and closing the discharge holes, a suction chamber communicating with the cylinder bores through the suction holes and the suction valves, and a discharge chamber communicating with the cylinder bores through the discharge valves and the discharge holes, and wherein the cylinder bores are circumferentially distanced from each other and located on the circumference of a first circle, the suction holes are circumferentially distanced from each other and located on the circumference of a second circle, and the discharge holes are circumferentially distanced from each other and located on the circumference of a third circle, and wherein the method comprises the step of making any one of a resin coat, plated metal coat, thermal sprayed material coat, sintered metal coat and ceramic coat on the end face of the valve plate contacting the suction valves at a continuous annular portion close to all of the suction holes and/or the end face of the valve plate contacting the discharge valves at a continuous annular portion close to all of the discharge holes to project the coated portions from the remaining uncoated portions.

15. The method for processing contact portions between a valve plate and a suction valve and/or discharge valve of a reciprocating compressor of claim 1, wherein the width of the projections is 0.1 mm to 2.0 mm.

16. The method for processing contact portions between a valve plate and a suction valve and/or discharge valve of a reciprocating compressor of claim 1, wherein the height of the projections is 0.01 mm to 0.5 mm.

17. The method for processing contact portions between a valve plate and a suction valve and/or discharge valve of a reciprocating compressor of claim 1, wherein surface roughness of the projections is smaller than that of the remaining flat portions.

18. A method for processing contact portions between a valve plate and a suction valve and/or discharge valve of a reciprocating compressor of claim 17, wherein surface roughness of the projections is Rz10 or less.

19. The method for processing contact portions between a valve plate and a suction valve and/or discharge valve of a reciprocating compressor of claim 1, wherein hardness of the quenched portions is higher than that of the unquenched portions by HV100 or more.

20. The method for processing contact portions between a valve plate and a suction valve and/or discharge valve of a reciprocating compressor of claim 1, wherein the laser beam machining is CO₂ laser beam machining.

21. The method for processing contact portions between a valve plate and a suction valve and/or discharge valve of a reciprocating compressor of claim 2, wherein the resin coat is a fluoride resin coat.

22. A method for processing contact portions between a valve plate and a suction valve and/or discharge valve of a reciprocating compressor of claim 21, wherein the binder of the resin coating is at least one selected from the group consisting of polyamideimide, epoxy, polyimide, polyamide, and polyether ether ketone.

23. The method for processing contact portions between a valve plate and a suction valve and/or discharge valve of a reciprocating compressor of claim 2, wherein the resin coat is made by screen printing.

24. The method for processing contact portions between a valve plate and a suction valve and/or discharge valve of a reciprocating compressor of claim 2, further comprising the step of any one of chemical conversion treating. Tufftride processing and shot blasting the end faces to be resin coated before the step of making resin coat.

25. The method for processing contact portions between a valve plate and a suction valve and/or discharge valve of a reciprocating compressor of claim 2, wherein the sintered metal coat is porous coat.

26. A method for processing contact portions between a valve plate and a suction valve and/or discharge valve of a reciprocating compressor of claim 25, further comprising the step of impregnating the sintered metal coat with PTFE, i.e., polytetrafluoroethylene.

27. The reciprocating compressor, wherein the contact portions between a valve plate and a suction valve and/or discharge valve are processed by the method of claim 1.
